(19) United States
(12) Patent Application Publication
(10) Pub. No.: US 2014/0176427 A1
(43) Pub. Date: Jun. 26, 2014

(54) ELECTRONIC DEVICE AND METHOD FOR ADJUSTING DISPLAY SCREEN

(71) Applicants: HON HAI PRECISION INDUSTRY CO., LTD., New Taipei (TW); HONG FU JIN PRECISION INDUSTRY (WuHan) CO., LTD., Wuhan (CN)

(72) Inventors: XIN-SHU WANG, Wuhan (CN); JIAN-HUNG HUNG, New Taipei (TW)

(73) Assignees: HON HAI PRECISION INDUSTRY CO., LTD., New Taipei (TW); HONG FU JIN PRECISION INDUSTRY (WUHAN) CO., LTD., Wuhan (CN)

(21) Appl. No.: 14/135,406

(22) Filed: Dec. 19, 2013

(30) Foreign Application Priority Data
Dec. 25, 2012 (CN) 2012105724903

(51) Int. Cl. G06F 3/01; G06T 3/60

(52) U.S. Cl. CPC G06F 3/017; G06T 3/60
USPC 345/156

(57) ABSTRACT

In a method for adjusting a display screen of an electronic device, the method obtains a current image of a user captured by an image capturing device installed on the display screen, detects a gesture of the user from the current image, and determines a gesture template matched with the detected gesture. The method further rotates the display screen according to a preset operation corresponding to the matched gesture template, and stops rotating the display screen when a preset gesture for stopping rotating the display screen is detected from the current image.

### BACKGROUND

1. Technical Field

Embodiments of the present disclosure relate to automatic control technology, and particularly to an electronic device and a method for adjusting a display screen of the electronic device.

2. Description of Related Art

Display screens of an electronic device are often fixed in one position or need to be rotated by hand. However, it is inconvenient to adjust the position of the display screen by hand. Therefore, a method for adjusting a display screen of an electronic device is desired.

### BRIEF DESCRIPTION OF THE DRAWINGS

FIG. 1 is a block diagram of one embodiment of an electronic device including a display screen adjusting system.

FIG. 2 is a block diagram of function modules of the display screen adjusting system included in the electronic device.

FIG. 3 is a flowchart of one embodiment of a method for adjusting a display screen of the electronic device.

FIG. 4 is a schematic diagram of a front view of the display screen.

FIG. 5 is a schematic diagram of a side view of the display screen.

FIG. 6 shows schematic diagrams of a plurality of preset gesture templates.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.”

All of the processes described below may be embodied in, and fully automated via, functional code modules executed by one or more general purpose electronic devices or processors. The code modules may be stored in any type of non-transitory computer-readable medium or other storage device. Some or all of the methods may alternatively be embodied in specialized hardware. Depending on the embodiment, the non-transitory computer-readable medium may be a hard disk drive, a compact disc, a digital video disc, a tape drive or other suitable storage medium.

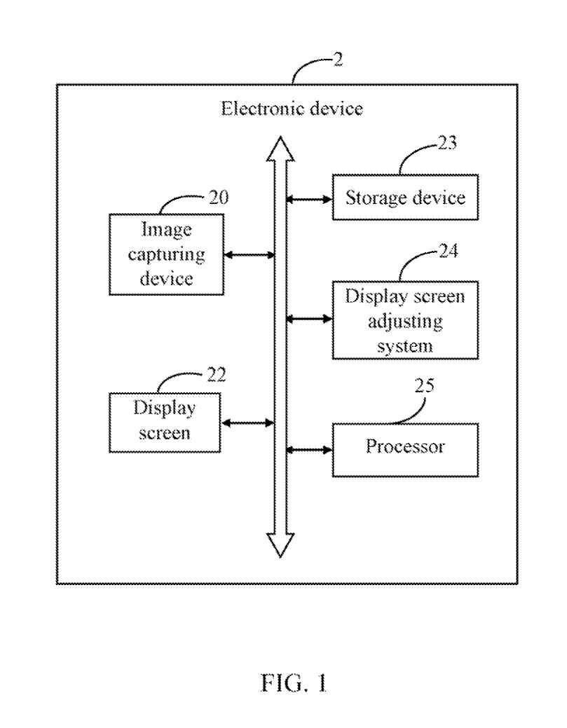

FIG. 1 is a block diagram of one embodiment of an electronic device 2 including a display screen adjusting system 24. The electronic device 2 further includes an image capturing device 20, a display screen 22, a storage device 23, and at least one processor 25. It should be understood that FIG. 1 illustrates only one example of the electronic device 2, which may include more or fewer components than illustrated, or a different configuration of the various components in other embodiments. In one embodiment, the electronic device 2 is a desktop computer.

In one embodiment, the processor 25 is an embedded controller of a single chip microcomputer (SCM), such as a 8032 AH. A working voltage of the processor 25 is about three volts (V).

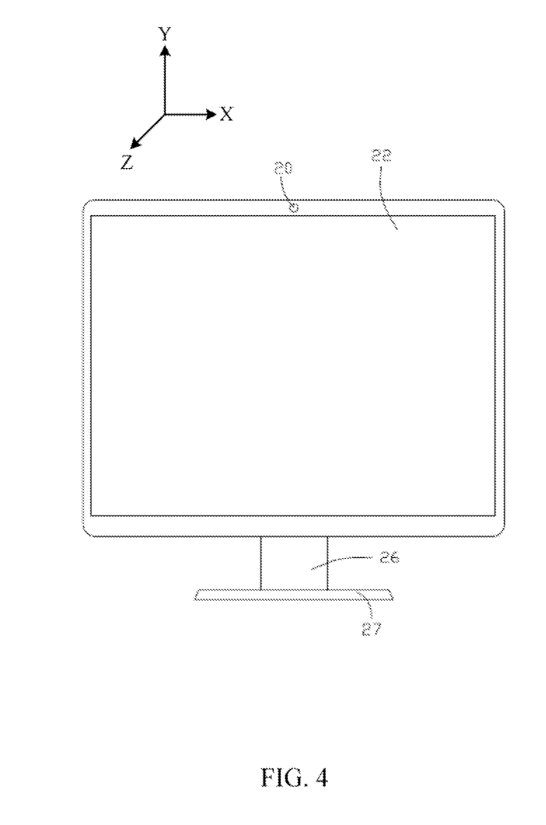

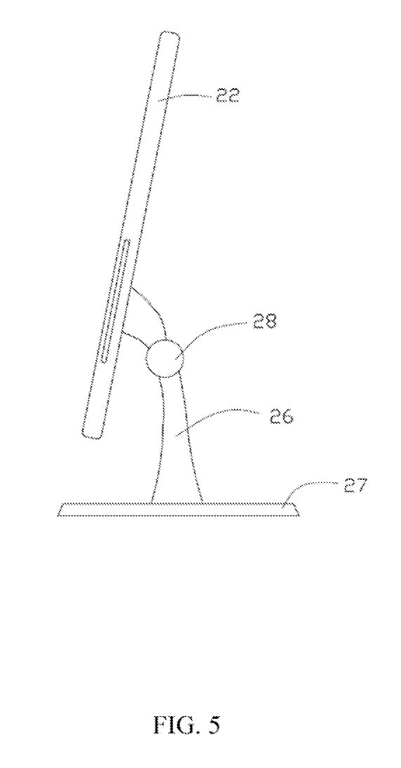

As shown in FIG. 4, the image capturing device 20 is located in a substantially middle portion of a top border of the display screen 22. The display screen 22 is connected to a pedestal 27 through a bracket 26. In addition, as shown in FIG. 5, a rotating bearing 28 is located in the bracket 26. The rotating bearing 28 is a spherical bearing. A driving motor is installed in the bracket 26, and the rotating bearing 28 is rotated by the driving motor. Thus, the display screen 22 is controlled to rotate in accordance with the rotating of the rotating bearing 28.

In one embodiment, the image capturing device 20 is used to capture images of a user and store the captured images in the storage device 23. For example, the image capturing device 20 may be a three dimensional (3D) camera, which captures about ten images per second (10 frames/s).

The display screen adjusting system 24 obtains the captured images from the storage device 23, detects hand gestures (hereinafter referred to as “gestures”) from the captured images, and rotates the display screen 22 according to the gestures of the user. In one embodiment, the display screen adjusting system 24 includes computerized instructions in the form of one or more programs that are executed by the processor 25 and stored in the storage device 23 (or memory). A detailed description of the display screen adjusting system 24 will be given in the following paragraphs.

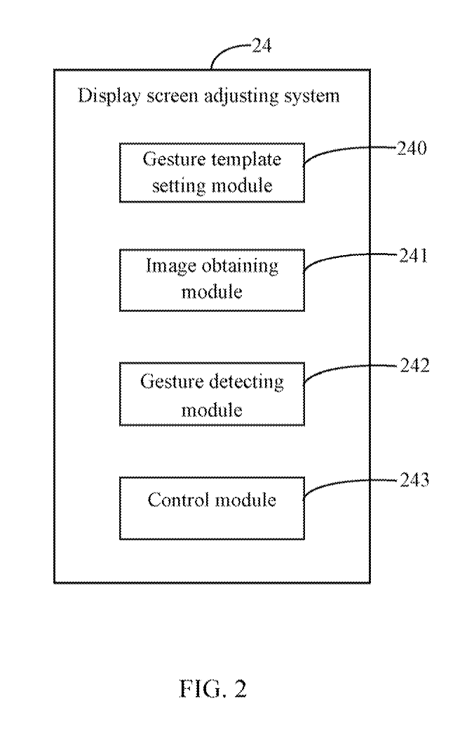

FIG. 2 is a block diagram of function modules of the display screen adjusting system 24 included in the electronic device 2. In one embodiment, the display screen adjusting system 24 may include one or more modules, for example, a gesture template setting module 240, an image obtaining module 241, a gesture detecting module 242, and a control module 243. In general, the word “module”, as used herein, refers to logic embodied in hardware or firmware, or to a collection of software instructions, written in a programming language, such as, Java, C, or assembly. One or more software instructions in the modules may be embedded in firmware, such as in an EPROM. The modules described herein may be implemented as either software and/or hardware modules and may be stored in any type of non-transitory computer-readable medium or other storage device. Some non-limiting examples of non-transitory computer-readable medium include CDs, DVDs, BLU-RAY, flash memory, and hard disk drives.

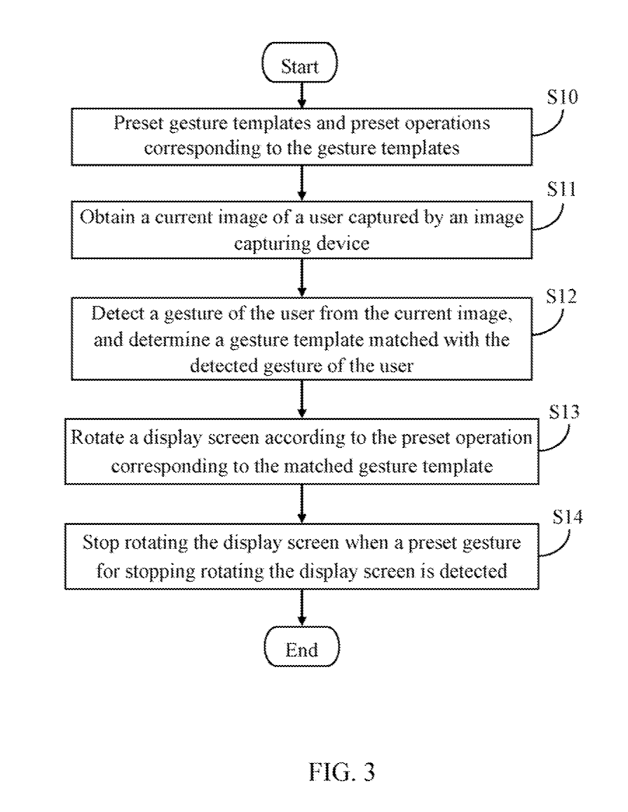

FIG. 3 is a flowchart of one embodiment of a method for adjusting the display screen 22 of the electronic device 2. Depending on the embodiment, additional steps may be added, others removed, and the ordering of the steps may be changed.

In step S10, the gesture template setting module 240 presets gesture templates and preset operations corresponding to the preset gesture templates for adjusting the display screen 22, and stores the preset gesture templates and the preset operations in the storage device 23. In one embodiment, the preset gesture templates include a first type of gesture templates for controlling rotation directions of the display screen 22 (hereinafter “direction gesture templates”) and a second type of gesture templates for controlling the display screen 22 for stopping the display screen 22 from rotating (hereinafter “stop gesture templates”).

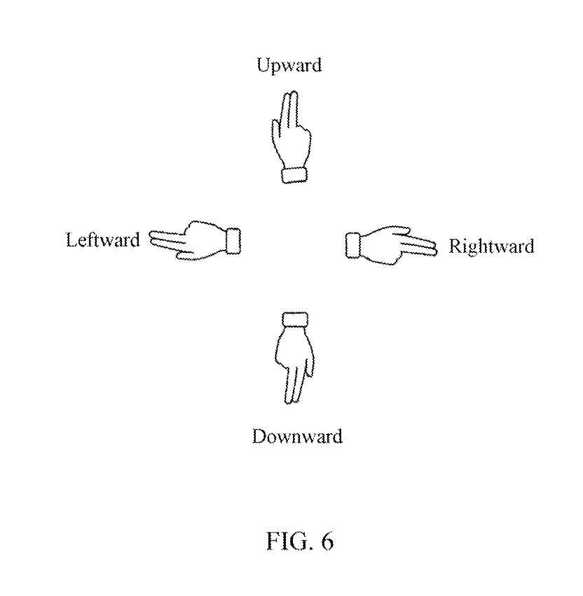

For example, as shown in FIG. 6, four direction gesture templates are preset. The four direction gesture templates include an upward gesture template, which is used to control the display screen 22 to rotate upward, a downward gesture template, which is used to control the display screen 22 to rotate downward, a leftward gesture template, which is used to control the display screen 22 to rotate leftward, and a rightward gesture template, which is used to control the display screen 22 to rotate rightward. In one embodiment, one stop gesture template is preset. For example, the stop gesture template is an “OK” sign of the user's hand. When the user makes the “OK” sign in front of the image capturing device 20, an image of the stop gesture template is obtained by the image capturing device 20.

In step S11, the image obtaining module 241 obtains a current image of a user captured by the image capturing device 20 from the storage device 23.

In step S12, the gesture detecting module 242 detects a hand gesture (hereinafter referred to as “gesture”) of the user from the current image, and determines a gesture template matched with the detected gesture of the user from the preset gesture templates. In one embodiment, the gesture detecting module 242 may detects the gesture of the user from the current image using an Skeletal-based recognition algorithm, or an appearance-based recognition model, or other suitable gesture detection methods.

In one embodiment, if a similarity between a specified gesture template and the detected gesture is greater than a preset proportion (e.g., 95%), the gesture detecting module 242 determines that the specified gesture template matches the detected gesture. In one embodiment, the similarity is determined according to a similarity of pixels (pixel similarity) between each preset gesture template and the detected gesture. In one embodiment, if a difference in a parameter value (e.g., a gray scale) between a first pixel in the specified gesture template and a second pixel corresponding to the first pixel in the detected gesture is less than a preset value (e.g., five), the first pixel in the specified gesture template and the second pixel in the detected gesture are determined to be similar. For example, if the pixel similarity between the rightward gesture template and the detected gesture is greater than 95% (i.e., 95% of pixels in the rightward gesture template and the detected gesture are similar), the gesture detecting module 242 determines that the matched gesture template corresponding to the detected gesture is the rightward gesture template, and the display screen 22 needs to be rotated rightward.

In step S13, if the matched gesture template is one of the direction gesture templates, the control module 243 rotates the display screen 22 according to the preset operation corresponding to the matched gesture template by controlling the driving motor installed in the bracket 26 to rotate the rotating bearing 28, and then the display screen 22 is rotated. In other embodiments, the display screen 22 is rotated by other suitable motors such as a servo motor.

For example, the control module 243 rotates the display screen 22 leftward if the matched gesture template is the leftward gesture template. The control module 243 rotates the display screen 22 rightward if the matched gesture template is the rightward gesture template. The control module 243 rotates the display screen 22 upward if the matched gesture template is the upward gesture template. The control module 243 rotates the display screen 22 downward if the matched gesture template is the downward gesture template.

In step S14, the control module 243 stops rotating the display screen 22 when a preset gesture for stopping rotating the display screen 22 (the stop gesture template) is detected from the current image.

For example, if the display screen 22 is rotated to the left, when the user makes the “OK” gesture in front of the display screen 22, the control module 243 stops rotating the display screen 22 when the “OK” gesture is detected from the current images, so that a display orientation of the display screen 22 is directly opposite to the user's face, and an optimized visual effect is achieved. In one embodiment, the user is in front of the image capturing device 20 for the pixels in the captured images to be similar. For example, when the user moves left and make a gesture corresponding to the leftward gesture template, the display screen 22 is rotated to the left.

In other embodiments, a gravity sensor 21 is embedded in the electronic device 2. The gravity sensor 21 may be used to detect rotation angles of the display screen 22 along an X-axis direction, a Y-axis direction, and a Z-axis direction of the display screen 22, so that the display screen 22 can be rotated steadily under the control of the driving motor according to the detected rotation angles.

It should be emphasized that the above-described embodiments of the present disclosure, particularly, any embodiments, are merely possible examples of implementations, merely set forth for a clear understanding of the principles of the disclosure. Many variations and modifications may be made to the above-described embodiment(s) of the disclosure without departing substantially from the spirit and principles of the disclosure. All such modifications and variations are intended to be included herein within the scope of this disclosure and the present disclosure and protected by the following claims.

What is claimed is:

1. A method for adjusting a display screen of an electronic device, the method comprising:
obtaining a current image of a user captured by an image capturing device installed on the display screen;
detecting a gesture of the user from the current image, and determining a gesture template matched with the detected gesture of the user from preset gesture templates;
rotating the display screen according to a preset operation corresponding to the matched gesture template when the matched gesture template is one of preset direction gesture templates, the preset direction gesture templates being configured for controlling rotation directions of the display screen; and
stopping rotating the display screen when a preset gesture for stopping rotating the display screen is detected from the current image.

2. The method according to claim 1, further comprising: presetting gesture templates and preset operations corresponding to the preset gesture templates for adjusting the display screen, and stores the preset gesture templates and the preset operations in a storage device of the electronic device.

3. The method according to claim 1, wherein the gesture of the user is detected from the current image using an Skeletal-based recognition algorithm, or an appearance-based recognition model.

4. The method according to claim 1, further comprising: determining that a specified gesture template matches the detected gesture when a similarity between the specified gesture template and the detected gesture is greater than a preset proportion.

5. The method according to claim 1, wherein the display screen is rotated by controlling a driving motor installed in a bracket of the display screen rotating a rotating bearing of the bracket according to the preset operation corresponding to the matched gesture template.

6. An electronic device, comprising:
a processor;
a storage device storing a plurality of instructions, which when executed by the processor, causes the processor to:
obtain a current image of a user captured by an image capturing device installed on a display screen of the electronic device;
detect a gesture of the user from the current image, and determine a gesture template matched with the detected gesture of the user from preset gesture templates;
rotate the display screen according to a preset operation corresponding to the matched gesture template when the matched gesture template is one of preset direction gesture templates, the preset direction gesture templates being configured for controlling rotation directions of the display screen; and
stop rotating the display screen when a preset gesture for stopping rotating the display screen is detected from the current image.

7. The electronic device according to claim 6, wherein the plurality of instructions further comprise: presetting gesture templates and preset operations corresponding to the preset gesture templates for adjusting the display screen, and stores the preset gesture templates and the preset operations in a storage device of the electronic device.

8. The electronic device according to claim 6, wherein the gesture of the user is detected from the current image using an Skeletal-based recognition algorithm, or an appearance-based recognition model.

9. The electronic device according to claim 6, wherein the plurality of instructions further comprise: determining that a specified gesture template matches the detected gesture when a similarity between the specified gesture template and the detected gesture is greater than a preset proportion.

10. The electronic device according to claim 6, wherein the display screen is rotated by controlling a driving motor installed in a bracket of the display screen rotating a rotating bearing of the bracket according to the preset operation corresponding to the matched gesture template.

11. A non-transitory storage medium having stored thereon instructions that, when executed by a processor of a electronic device, causes the electronic device to perform a method for adjusting a display screen of the electronic device, the method comprising:
obtaining a current image of a user captured by an image capturing device installed on the display screen;
detecting a gesture of the user from the current image, and determining a gesture template matched with the detected gesture of the user from preset gesture templates;
rotating the display screen according to a preset operation corresponding to the matched gesture template when the matched gesture template is one of preset direction gesture templates, the preset direction gesture templates being configured for controlling rotation directions of the display screen; and
stopping rotating the display screen when a preset gesture for stopping rotating the display screen is detected from the current image.

12. The non-transitory storage medium according to claim 11, wherein the method further comprises: presetting gesture templates and preset operations corresponding to the preset gesture templates for adjusting the display screen, and stores the preset gesture templates and the preset operations in a storage device of the electronic device.

13. The non-transitory storage medium according to claim 11, wherein the gesture of the user is detected from the current image using an Skeletal-based recognition algorithm, or an appearance-based recognition model.

14. The non-transitory storage medium according to claim 11, wherein the method further comprises: determining that a specified gesture template matches the detected gesture when a similarity between the specified gesture template and the detected gesture is greater than a preset proportion.

15. The non-transitory storage medium according to claim 11, wherein the display screen is rotated by controlling a driving motor installed in a bracket of the display screen rotating a rotating bearing of the bracket according to the preset operation corresponding to the matched gesture template.
